(19) United States
(12) Patent Application Publication
(10) Pub. No.: US 2009/0227180 A1
(43) Pub. Date: Sep. 10, 2009

(54) Process for making a quick installation foundation frame

(76) Inventor: Joseph P. Papalia, Louisville, KY (US)

Correspondence Address: Jeannie E. Presley, 164 Seal Rock Dr., San Francisco, CA, 94121, US

(21) Appl. No.: 12/221,055

(22) Filed: Jul. 31, 2008

Related U.S. Application Data
(60) Provisional application No. 61/033,468, filed on Mar. 4, 2008.

(51) Int. Cl. A01K 47/02; B23P 11/00

(52) U.S. Cl. 449/43; 29/428; 29/525.01; 449/42

(57) ABSTRACT

A bee cabinet houses a plurality of removable foundation frames in a predetermined space within the cabinet upon which honey bees produce honey comb. By constructing thicker, grooved side bars and a grooved bottom bar, along with a slotted. wedged top bar, the beeswax foundation can be more easily installed. This construction saves the bee keeper a significant amount of time as well as making it more economically viable to provide the bees their preferred substrate on which to build.

### CROSS-REFERENCE TO RELATED APPLICATIONS

The present application claims the benefit of U.S. Provisional Patent Application Ser. No. 61/033,468, the contents of which are incorporated by reference in its entirety.

### STATEMENT REGARDING FEDERALLY SPONSORED RESEARCH OR DEVELOPMENT

Not Applicable.

### THE NAMES OF THE PARTIES TO A JOINT RESEARCH AGREEMENT Not Applicable.

### INCORPORATION-BY-REFERENCE OF MATERIAL SUBMITTED ON A COMPACT DISC

Not Applicable.

### BACKGROUND OF THE INVENTION

(1) Field of the Invention

The present invention relates to a beehive system for the manufacture of bee products, and more particularly to a new and improved process for making a frame which allows a quick foundation installation.

(2) Description of the Related Art Including Information Disclosed Under 37 CFR 1.97 and 1.98.

To this point, beeswax foundations have been secured in a frame by grooves situated on both the interior of the top and bottom bars of the frame. The Langstroth frame as shown in U.S. Pat. No. 9,300 demonstrates that the foundation has previously been fastened to the side bars of the frame with support pins or wires to provide the requisite support for withstanding the weight of honey comb, but which causes damage to the foundation. A second variation also exists which is a one-piece plastic frame/foundation that does not require pins or nails, as demonstrated in U.S. Pat. No. 6,530,819. Though the '819 patent provides for a durable frame, the prior art does not allow installation of the beeswax foundation and is not as desirable to the honey bees as the wood and wax variation.

### BRIEF SUMMARY OF THE INVENTION

An object of the present invention is to allow for more efficient collection of bee products.

Another object of the present invention is to provide a natural beeswax foundation to assist honey bees with their production of honeycomb.

A further object of the present invention is to provide a frame for the foundation which does not cause damage or disfigurement to the foundation upon its installation into the frame.

Yet another object of the present invention is to allow for quick and easy removal and installation of the foundation for cleaning and reuse of the frame.

These, together with other objects and advantages which will become subsequently apparent, lie in the details of construction and operation as more fully hereinafter described, reference being had to the accompanying drawings forming a part hereof, wherein like numerals refer to like parts throughout.

### BRIEF DESCRIPTION OF THE SEVERAL VIEWS OF THE DRAWINGS

FIG. 1 shows a front view of the frame.

FIG. 2A shows the exterior view of the top slotted bar of the frame.

FIG. 2B shows a front view of the top slotted bar of the frame.

FIG. 2C shows the interior view of the top slotted bar of the frame.

FIG. 3A shows the interior view of an end bar of the frame.

FIG. 3B shows the exterior view of an end bar of the frame.

FIG. 3C shows a left-side view of an end bar of the frame.

FIG. 4A shows the interior view of the bottom bar of the frame.

FIG. 4B shows the side view of the bottom bar of the frame.

FIG. 4C shows the bottom view of the bottom bar of the frame.

### DETAILED DESCRIPTION OF THE INVENTION

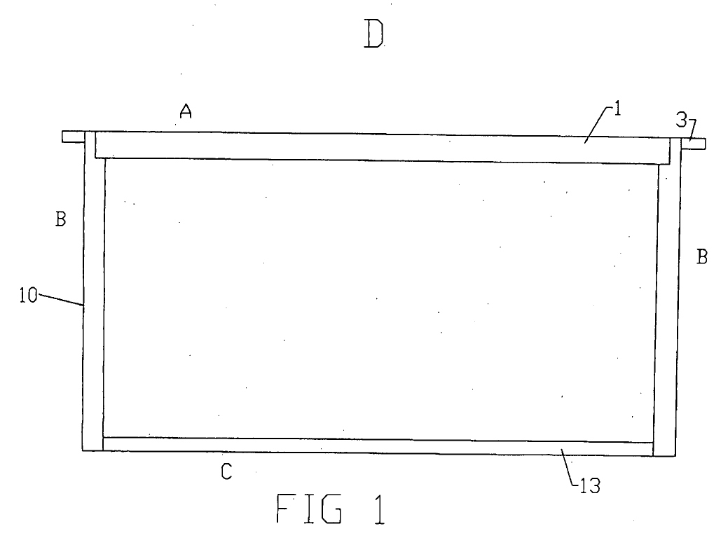

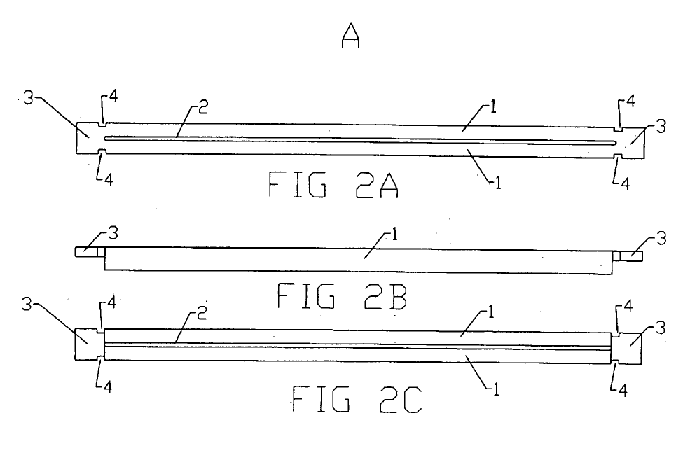

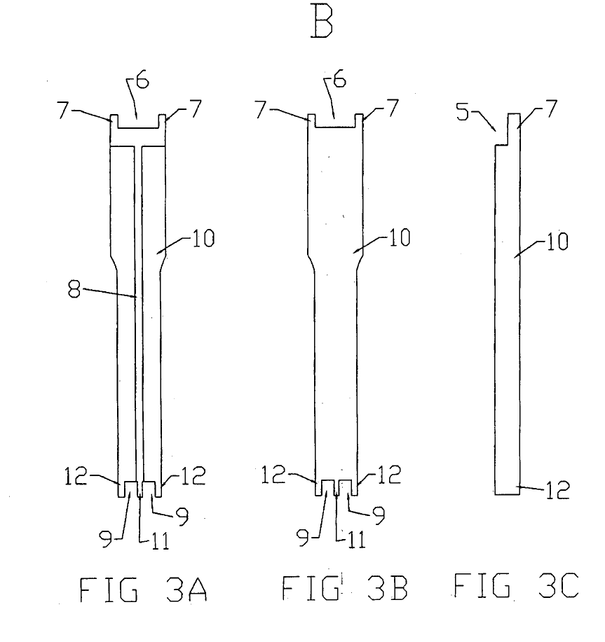

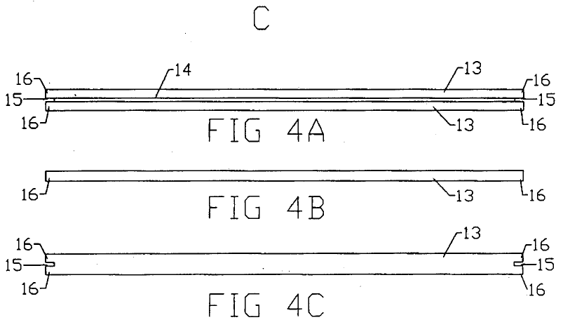

The four-sided frame (D) as shown in FIG. 1 is comprised of four bars by which a top bar (A) as shown in FIG. 1 and FIGS. 2A-2C, two end bars (B) as shown in FIG. 1 and FIGS. 3A-3C and a bottom bar (C) as shown in FIG. 1 and FIGS. 4A-4C adjoin to form comers and are attached by staples, nails and/or adhesive. Each bar (A)(B)(C) is interconnected by precisely-spaced linking cut-away ruts (4)(5)(6)(9)(15) and extensions from the main body of the bars which create notches (3)(7)(12)(16). These ruts (4)(5)(6)(9)(15) and notches (3)(7)(12)(16) are located on the end of each bar (A)(B)(C). Each identical end bar (B) is situated parallel to the other with its interior facing the opposing side bar (B). The top bar (A) and bottom bar (C) are situated parallel to one another with their interiors facing the opposing bar and are situated perpendicular to the side bars (B).

While the end bars (B) are identical to one another, the top bar (A) and bottom bar (B) differ in that the wedged outer extensions (3) of the top bar (A) protrude laterally past the end bars (B) as shown in FIG. 1. These extensions (3) allow the frame (D), to be situated in a fixed position within the provided space in a beehive cabinet, such as a Langstroth cabinet. The bottom bar (C) as seen in FIG. 1 and FIGS. 4A-4C contains an interior longitudinal groove (14) as a means for supporting the bottom of the foundation (D). Each end bar (B) also contains an interior longitudinal groove (8) as shown in FIG. 3A to add support to the sides of the foundation. By the implementation of the supporting slot (2) within the center of the top bar's (A) outer edges (1), the end groove (8) in the center of each end bar's (B) outer edges (10) and the bottom groove (14) the in the center of the bottom bar's (C) outer edges (13), the new and improved frame (D) no longer requires support pins or wire to brace the foundation. Thus, the beeswax foundation can be more easily installed. This construction saves the bee keeper a significant amount of time as well as making it more economically viable to provide the bees with their preferred substrate on which to build. The frame can be made of various substances, though the preferred embodiment is constructed of wood.

1.) A method for manufacturing a frame, comprising:
(a) providing top, bottom and side bars, said bottom bar and said side bars possessing interior longitudinal grooves and said top bar possessing a longitudinal slot, whereby providing a means for inserting a foundation, and
(b) connecting said top bar and said bottom bar to said side bars with an attachment means for connecting said bars, such that said interior longitudinal grooves within said bottom and said side bars provide a contiguous support system for said foundation within said frame.

2.) The method of claim 1 wherein said top bar is constructed such that said bar's edges extend laterally past said side bars, thereby creating a means for said frame to be rested in a predetermined hanging space.

3.) The method of claim 1 wherein said top and said bottom bars are connected to said side bars by using a system of interlocking ruts and notches, thus creating a contiguous frame.

4.) The method of claim 3 further including a reinforcement means such as staples, nails, or adhesive to stabilize said means for connecting said bars.

5.) The method of claim 1 wherein said attachment means for connecting said top bar and said bottom bar with said side bars is comprised of staples, nails, or adhesive.

6.) The method of claim 1 wherein said top, bottom, and side bars are made of wood.

7.) The method of claim 1 wherein said top, bottom, and side bars are made of plastic.

8.) The method of claim 1 wherein said frame is a solid and contiguous piece of plastic.

9.) The method of claim 1 having such dimensions such that said frame is appropriate for use in a Langstroth cabinet.

10.) The method of claim 1 wherein said top bar's edges extend laterally past said side bars, said top, bottom and side bars are connected by a system of interlocking ruts and notches, said reinforcement means is provided, said frame is made of wood, and said frame has such dimensions such that said frame is appropriate for use in a Langstroth cabinet.

11.) An article of manufacture comprising:
(a) a top bar,
(b) a bottom bar,
(c) side bars,
(d) said bottom bar and said side bars having interior longitudinal grooves,
(e) said top bar having a longitudinal slot, whereby said longitudinal slot provides a means for inserting a removable foundation,
(f) an attachment means for adjoining said top and bottom bars with said side bars at their ends.

12.) The article of manufacture of claim 11 wherein said top bar extends farther laterally than said side bars, such that the frame can be rested in a predetermined holding space.

13.) The article of manufacture of claim 11 wherein said attachment means adjoining said top and bottom bars to said side bars is comprised of interlocking ruts and notches, whereby creating a contiguous frame.

14.) The article of manufacture of claim 13 further including reinforcing means for connecting said interlocking ruts and notches, such as staples, nails, or adhesive.

15.) The article of manufacture of claim 11 wherein said attachment means adjoining said top and bottom bars to said side bars is comprised of staples, nails, or adhesive.

16.) The article of manufacture of claim 11 wherein said top, bottom, and side bars are made of wood.

17.) The article of manufacture of claim 11 wherein said top, bottom, and side bars are made of plastic.

18.) The article of manufacture of claim 11 wherein said frame is a solid and contiguous piece of plastic.

19.) The article of manufacture of claim 11 wherein said frame consists of such dimensions for appropriate use in a Langstroth cabinet.

20.) The article of manufacture of claim 11 wherein said top bar's edges extend laterally past said side bars, said top, bottom, and side bars are connected by a system of interlocking ruts and notches, said reinforcement means is provided, said frame is made of wood, and said frame has such dimensions such that said frame is appropriate for use in a Langstroth cabinet.
